(19) United States
(12) Patent Application Publication
(10) Pub. No.: US 2018/0146813 A1
(43) Pub. Date: May 31, 2018

(54) Fully-Automatic Intelligent Multi-Wok Cooking Method

(71) Applicants: BOYUN WANG, Ann Arbor, MI (US); ZIYAN WANG, Pudong (CN)

(72) Inventors: BOYUN WANG, Ann Arbor, MI (US); ZIYAN WANG, Pudong (CN)

(21) Appl. No.: 15/820,981

(22) Filed: Nov. 22, 2017

(30) Foreign Application Priority Data
Nov. 25, 2016 (CN) CN201611053719.7

(51) Int. Cl. A47J 27/12

(52) U.S. Cl. CPC A47J 27/12

(57) ABSTRACT

The invention relates to the technical field of robotics, in particular to a fully-automatic intelligent multi-wok cooking method. The cooking method is characterized in that it includes at least the following steps: a driving mechanism drives the cooking woks to the food ingredient storage and supply system for ingredient fetching; after ingredient fetching action is completed, the cooking woks are heated while being rotated for wok tossing; wok moving, ingredient fetching, wok heating and tossing repeats until cooking completes, the cooking wok(s) is(are) then driven to the product delivery system for dishing. The said cooking method has the advantages that: fully-automatic cooking process is realized, including various functions such as stir frying, stewing, washing, dishing and etc.; multiple different dishes can be cooked at the same time; the cooking robot based on said cooking method has a compact structure and a small footprint, which is convenient for layout; required cooking wok motion range and total moving distance are reduced, thus reducing the time for cooking each dish; structure of a cooking robot body can be simplified in a disguised manner to lower the requirements for the operating precision of the cooking robot.

### FIELD OF THE INVENTION

The present invention relates to the technical field of robotics, in particular to a fully-automatic intelligent multi-wok cooking method.

### DESCRIPTION OF THE RELATED ART

In recent years, as commercial cooking automation needs growing day by day, people have invested a lot of human resources and financial resources to conduct research and development of intelligent Chinese dish cooking robots.

An invention patent with the application number of 03132182.8 discloses a solution, in which a mechanical arm is adopted to realize various actions of a traditional human chef. The mechanical arm is adopted to grab prepared food ingredients from a food ingredient storage area, transfer the same into the cooking area and pour the same into a cooking wok held by the mechanical arm. There are lower-cost schemes adopting a multiple-DoF mechanism to replace the mechanical arm in similar design. However, it is a semi-automatic cooking robot, of which the food ingredient preparation area is operated by human user, who prepare various uncooked non-vegetarian and vegetarian food ingredients to be grabbed by the mechanical arm, thus lowering the cooking efficiency and causing trouble to the users.

An invention patent with the application number of 201110147659.6 discloses a fully-automatic cooking robot. The fully-automatic cooking robot mainly comprises a solid material preparation box with a solid meter and a weighing sensor, a stirrer for stir-frying food ingredients, a pot tossing mechanism and a heater, but the fully-automatic cooking robot is complex in structure, high in requirements on mechanism action, quite large in occupied space and bad for mass production.

A utility model patent with the application number of 200720002020.8 discloses a fully-automatic cooking system and relates to integrated system composition. The fully-automatic cooking system comprises vegetable washing, vegetable chopping, bowl washing, disinfecting and storage and preservation units or subsystems and related units and mechanisms, but the system has the aforementioned problems too.

### BRIEF SUMMARY OF THE INVENTION

The invention aims to provide a fully-automatic intelligent multi-wok cooking method according to the above defects of the prior art. The cooking woks are driven by the central cooking system to the ingredient fetch outlet and fetch ingredient from the food ingredient boxes on the mainframe structure, full automation of cooking is realized through cooperation between the central cooking system and a plurality of auxiliary systems, and the fully-automatic intelligent multi-wok cooking method has the advantages of compact structure and convenience in implementation and mass manufacturing.

The objective of the invention is achieved by the following technical scheme:

A fully-automatic intelligent multi-wok cooking method, which is characterized in that it includes at least the following steps: a driving mechanism drives the cooking woks to the food ingredient storage and supply system for ingredient fetching; after ingredient fetching action is completed, the cooking woks are heated while being rotated for wok tossing; wok moving, ingredient fetching, wok heating and tossing repeats until cooking completes, the cooking wok(s) is(are) then driven to the product delivery system for dishing.

The food ingredient storage and supply system is arranged on a mainframe structure and comprises a plurality of food ingredient boxes with food ingredient fetching outlets. The cooking woks move to the corresponding positions of the food ingredient fetching outlets that matched with the food ingredient boxes for ingredient fetching.

The movement of the cooking woks includes one of or a combination of two or more of rotating, ascending and descending, extending and contracting.

The rotating of a plurality of the cooking woks includes single-pot rotating and integral rotating. Said single-pot rotating angle range of the cooking woks is the result of 360 degrees divided by the number of the cooking woks.

Heating refers to pre-heating the cooking woks in the process when the cooking woks are moving. The heating temperature meets the requirements of cooking needs.

Wok tossing is realized by connecting one side of each cooking wok with a rotating shaft, that drives the individual cooking woks to rotate independent of each other.

Each rotating shaft rotates to drive the corresponding cooking wok to rotate; each rotating shaft is gradually accelerated from the static state with an angular velocity of 0 to a maximum angular velocity value; each rotating shaft is decelerated gradually to the static state with the angular velocity of 0 after reaching the maximum angular velocity value; and when being in the static state, the corresponding cooking wok is at its maximum angle position.

When performing time consuming slow cooking, the cooking wok(s), that is(are) performing the slow cooking, is(are) driven to move and is(are) transferred from the said driving mechanism onto an auxiliary cooking unit, and the auxiliary cooking unit continuously heats the cooking woks until the needs of slow cooking are met.

After cooking and/or dishing is completed, the corresponding cooking wok(s) is(are) driven to move and is(are) transferred from the driving mechanism onto a washing unit, and the washing unit washes the cooking woks.

The fully-automatic intelligent multi-wok cooking method has the advantages that: fully-automatic cooking process is realized, including various functions such as stir frying, stewing, washing, dishing and etc.; multiple different dishes can be cooked at the same time; the cooking robot based on said cooking method has a compact structure and a small footprint, which is convenient for layout; required cooking wok motion range and total moving distance are reduced, thus reducing the time for cooking each dish; structure of a cooking robot body can be simplified in a disguised manner to lower the requirements for the operating precision of the cooking robot; type, position and number of modularized bodies can be changed easily, quickly and conveniently according to the requirements on the cooking robot, and the modularized cooking robot has quite high customizability and replaceability; the cooking robot features simple and reasonable structure, attractive and elegant appearance and is suitable for popularization.

### DESCRIPTION OF DRAWINGS

FIG. 1 is a structural schematic view of the invention;

FIG. 2 is a structural schematic view of the cooking wok system;

FIG. 3 is a structural schematic view of the food ingredient box;

FIG. 4 is a structural schematic view of the auxiliary cooking area;

FIG. 5 is a top view of the invention.

### EMBODIMENTS

Features of the invention and other related features are further illustrated in details through embodiments combined with drawings as follows for the convenience of understanding by technical personnel of the same industry:

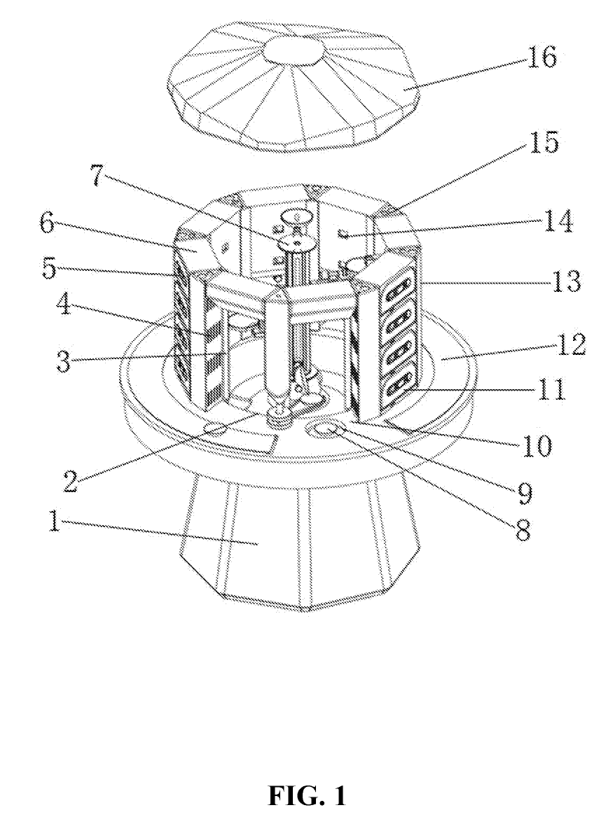

As shown in FIGS. 1-5, marks 1-37 in the Figures respectively refer to: 1—bottom cabinet, 2—dish gripper, 3—mainframe structure, 4—cold air passage, 5—food ingredient box, 6—ingredient box cabinet, 7—central cooking system, 8—dish bowl/plate, 9—dish bowl/plate storage box, 10—dishing passage, 11—ingredient box cabinet buckle, 12—dish bowl/plate conveying belt, 13—food ingredient box buckle, 14—food ingredient fetching outlet, 15—cold air pipeline, 16—refrigerating system, 17—lower inner rotating disc, 18—lower outer rotating disc, 19—electromagnetic heating stove, 20—cooking wok, 21—outer electric-controlled vertical sliding rail, 22—inner electric-controlled vertical sliding rail, 23—radial direction electric-controlled sliding rail, 24—servo motor base, 25—wok handle plug-pull joint, 26—wok handle plug, 27—wok handle, 28—plug-pull shaft, 29—servo motor, 30—upper inner rotating disc, 31—upper outer rotating disc, 32—central shaft, 33—cold air inlet, 34—auxiliary cooking area, 35—auxiliary wok handle socket, 36—wok washing water nozzle and 37—diverter.

Embodiment: the embodiment is realized through a fully-automatic intelligent multi-wok cooking device and is not limited to specific structural form of the cooking device. As shown in FIG. 1, the fully-automatic intelligent multi-wok cooking device comprises a bottom cabinet 1 which is used for supporting a mainframe structure 3 arranged above, and auxiliary equipment like a power distribution cabinet, an air refrigerator, an air compressor, a steam generator, a kitchen ventilator and a waste treatment unit can be arranged inside the body of the bottom cabinet.

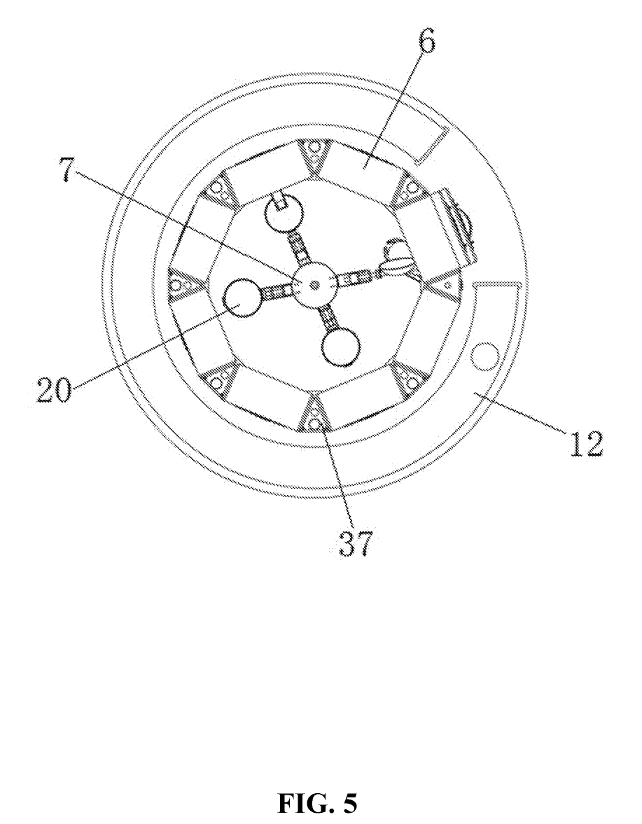

An area where the mainframe structure 3 is positioned is a working platform area. The mainframe structure 3 is a closed structure, having a polygonal shaped cross section, as is shown in FIG. 5. As shown in FIG. 1, an ingredient box cabinet 6 serving as a food ingredient box storage and ingredient fetching system is arranged on each long lateral side of the mainframe structure 3, and the ingredient box cabinets 6 are arranged along the vertical direction of the mainframe structure 3. The food ingredient cabinets 6 and the mainframe structure 3 are detachably connected and Fixed through ingredient box cabinet buckles 11; when food ingredients in the ingredient boxes 5 in the ingredient box cabinets 6 are used up or an auxiliary functional module needs to be arranged at a position, corresponding to the food ingredient box cabinet 6, of the mainframe structure 3 to replace the food ingredient box cabinet 6, the food ingredient box cabinet 6 can be demounted from the mainframe structure 3 so as to complete food ingredient supply or function replacement.

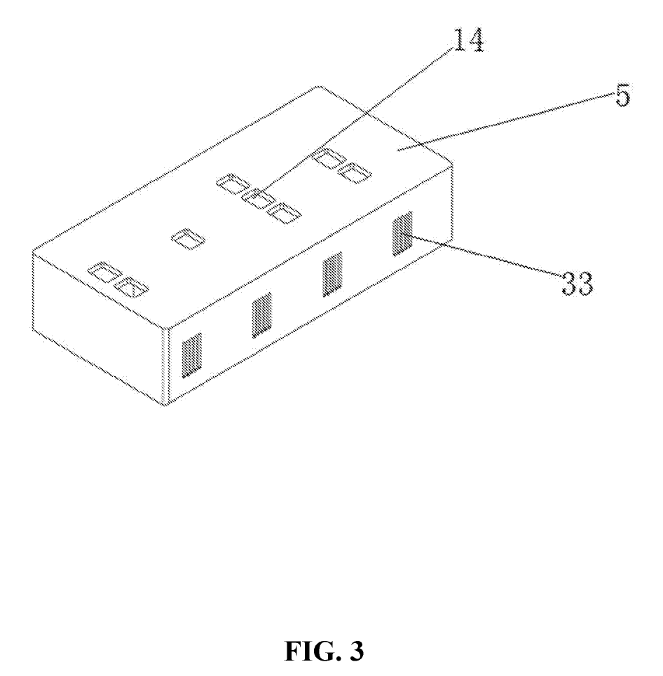

As shown in FIG. 1, each food ingredient box cabinet 6 is formed by combining four food ingredient boxes 5 which are used for storing food ingredients. The four food ingredient boxes 5 are stacked in the height direction and are connected and fixed to a frame of the food ingredient box cabinet 6 through food ingredient box buckles 13 to form a whole structure. During use, the food ingredient boxes 5 are connected and fixed to the frame of the food ingredient box cabinet 6 through the food ingredient box buckles 13, and the food ingredient box cabinet 6 with the food ingredient boxes 5 is connected and fixed to the mainframe structure 3 through ingredient box cabinet buckles II. As shown in FIG. 3, a plurality of food ingredient fetching outlets 14 are made on each food ingredient box 5, and food ingredients stored in the food ingredient box 5 can be discharged through the food ingredient fetching outlets 14.

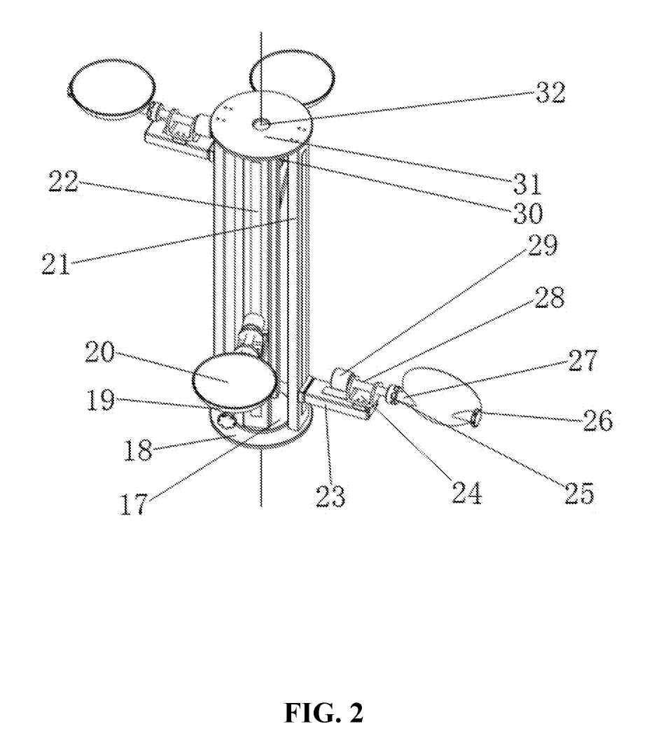

As shown in FIG. 1, a central cooking system 7 is arranged at the center of a closed area surrounded by the mainframe structure 3 and serves as a specific execution part of cooking operations. As shown in FIG. 2, the central cooking system 7 comprises a lower inner rotating disc 17 and a lower outer rotating disc 18 which are positioned below and can rotate relatively; an upper inner rotating disc 30 and an upper outer rotating disc 31 are arranged at corresponding positions above the lower inner rotating disc 17 and the lower outer rotating disc 18 and can rotate relatively, and the rotating of the lower inner and outer rotating discs 17 and 18 and the upper inner and outer rotating discs 30 and 31 can be driven and controlled by a central shall 32. The lower inner rotating disc 17 and the upper inner rotating disc 30 are connected through two groups of inner electric-controlled vertical sliding rails 22 in symmetric arrangement, and the lower outer rotating disc 18 and the upper outer rotating disc 31 are connected through two groups of outer electric-controlled vertical sliding rails 21 in symmetric arrangement. Radial direction electric-controlled sliding rail 23 is arranged on each group of the inner electric-controlled vertical sliding rail 22 and the outer electric-controlled vertical sliding rail 21 respectively and can move longitudinally (vertically) on the respective vertical electric-control sliding rail. A servo motor base 24 is arranged on each radial direction electric-controlled sliding rail 23 and can slide on the same, a servo motor 29 is fixedly arranged on each servo motor base 24, a plug-pull shaft 28 (rotating shaft) on each servo motor 29 is connected with a wok handle 27 of the corresponding cooking wok 20 through a wok handle plug-pull joint structure 25 to complete the fixing of the corresponding cooking wok 20. Radial (horizontal) extending and contracting of each cooking wok 20 is realized through the sliding of the corresponding servo motor base 24 on the corresponding radial direction electric-controlled sliding rail 23. A wok handle plug 26 is arranged on each cooking wok 20, positioned on the opposite side of the corresponding wok handle 27 and used for transferring the corresponding cooking wok 20 to other auxiliary functionality with auxiliary wok handle socket 35.

Depending on the above structure, the movement of the cooking woks 20 can be divided into following three types:

1) Rotating: the cooking woks 20 rotate independently or synchronously through rotating of the lower inner rotating disc 17, the lower outer rotating disc 18, the upper inner rotating disc 30 and the upper outer rotating disc 31; wherein independent rotating refers to that two cooking woks 20 arranged on the inner electric-controlled vertical sliding rails 22 (between the lower inner rotating disc 17 and the upper inner rotating disc 30) can rotate relative to two cooking woks 20 arranged on the outer electric-controlled vertical sliding rail 21 (between the lower outer rotating disc 18 and the upper outer rotating disc 31), in other words, inner rings do not rotate while outer rings rotate or inner rings rotate while outer rings do not rotate, and independent rotating angle is a product acquired by dividing 360 degrees with number of the cooking woks 20; while synchronous rotating refers to that the two cooking woks 20 arranged on the inner electric-controlled vertical sliding rails 22 (between the lower inner rotating disc 17 and the upper inner rotating disc 30) can rotate relative to two cooking woks 20 arranged on the outer electric-controlled vertical sliding rail 21 (between the lower outer rotating disc 18 and the upper outer rotating disc 31) rotate synchronously. Either independent rotating or synchronous rotating needs to take into consideration the space occupying interference problem among the cooking woks 20, wherein the space occupying interference problem is avoid through software programming of the central cooking system 7 motion, and device damage caused by colliding among the inner electric-controlled vertical sliding rails 22 and the outer electric-controlled vertical sliding rails is avoided, and coordination among different actions is improved.

As shown in FIG. 1, the cooking woks 20 rotate with the central cooking system 7 and move to the corresponding ingredient box cabinets 6 that are positioned around in circular. Various different food ingredients are stored in the ingredient box cabinets 6. When the cooking device receives an software instruction for cooking a certain dish, the various food ingredients needed for cooking the dish are generally distributed in the food ingredient boxes 5 at different positions, at the moment, the central cooking system 7 rotates the cooking woks 20 through the above mechanism to align the cooking woks 20 to the correct ingredient box cabinets 6 for ingredient fetching.

2) Ascending and descending: the cooking woks 20 can vertically (longitudinally) move on the respective inner electric-controlled vertical sliding rails 22 and outer electric-controlled vertical sliding rails 21 in a mutually independent manner, in other words, each cooking wok 20 can move on its electric-controlled vertical sliding rails 22 independently.

As shown in FIG. 1, the food ingredient cabinet 6 is composed of four stacked food ingredient boxes 5 at different height. When one cooking wok 20 rotates with the central cooking system 7 and reaches a corresponding direction of the food ingredient box cabinet 6, the central cooking system 7 drives the cooking wok 20 to ascend and descend through the electric-controlled vertical sliding rails to align the cooking wok 20 to the corresponding food ingredient boxes 5 for ingredient fetching.

3) Extending and contracting: each cooking woks 20 can radially extend and contract through sliding of the servo motor bases 24 on the radial direction electric-controlled rails 23 in a mutually independent manner, in other words, each cooking wok 20 can radially extend and contract independently on the corresponding radial direction electric-controlled sliding rail 23.

As shown in FIG. 1, when one cooking wok 20 rotates, ascends and descends and is aligned to the food ingredient box 5 corresponding to the food ingredients to be fetched, a certain distance exists between the cooking wok 20 and the food ingredient box 5. In order to complete material fetching action, the central cooking system 7 can drive the corresponding radial direction electric-controlled sliding rail 23 to drive the corresponding servo motor base 24 to slide so as to drive the cooking wok 20 to extend and contract to enable the cooking wok 20 to align to the food ingredient fetching outlet 14 of the food ingredient box 5.

At the moment, ingredient fetching can be realized by one of or a combination of the following steps:

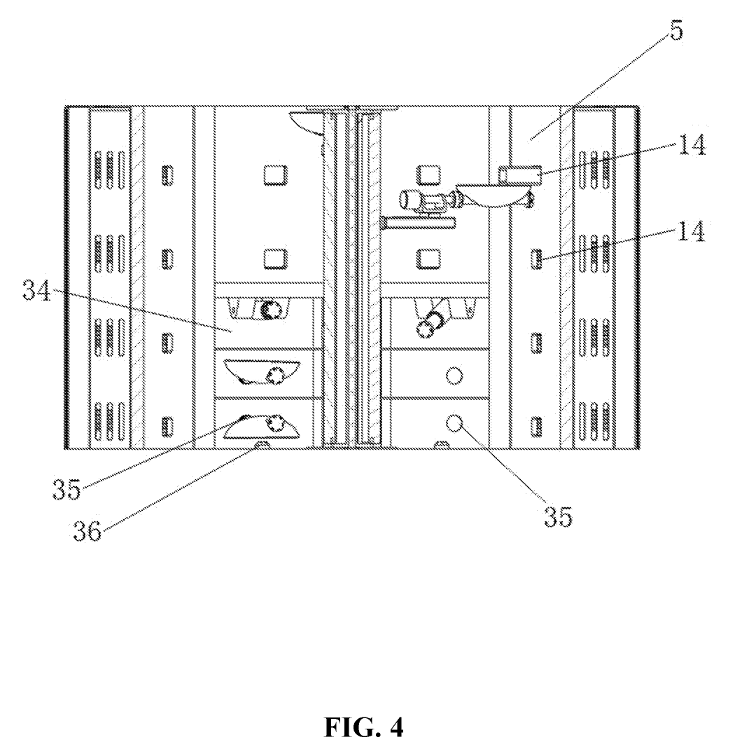

As shown in FIG. 4, the food ingredient box 5 includes a drawer pushing mechanism that pushes an ingredient fetching structure through the food ingredient fetching outlet 14, so that the ingredient fetching spot is extended towards the cooking wok 20.

Cooking wok 20 move radially towards the food ingredient fetching outlet 14.

The combination of the two steps refers to a combination of the above steps, in other words, the cooking wok 20 moves for a certain distance, and a pushing mechanism pushes for a certain distance.

During or after the ingredient fetching to a cooking wok 20, as shown in FIG. 2, an electromagnetic heating stove 19 arranged at the bottom of the cooking wok 20 serves as a heating unit and heats the cooking wok 20 to complete dish cooking process. The electromagnetic heating stove 19 can be started using an energy supply unit arranged in the wok handle plug-pull joint 25, in other words, an energy supply joint is arranged hi the wok handle plug-pull joint 25, and when the cooking wok 20 is connected to the wok handle plug-pull joint 25, the energy supply joint and the electromagnetic heating stove 19 are connected to power the electromagnetic heating stove 19 to heat the cooking wok 20.

Various seasonings like liquid, solid and colloid needed during dish cooking can all be arranged in the food ingredient boxes 5, or seasoning supply can be realized by arranging additional seasoning supply units.

As shown in FIG. 2, each cooking wok 20 is connected with the plug-pull shaft 28 of the corresponding servo motor 29, and each servo motor 29 functions in driving the corresponding plug-pull shaft 28 to rotate to drive the corresponding cooking wok 20 to rotate so as to simulate stir-frying action. To be more specific, 1) each plug-pull shaft 28 driven by the corresponding servo motor 29 can forward rotating and backward rotating (respectively corresponding to clockwise and counterclockwise of the cooking wok 20) to realize forward and backward wok tossing. Taking forward wok tossing as an example, each servo motor 29 drives the corresponding plug-pull shaft 28 to rotate forwards, the corresponding plug-pull shaft 28 drives the cooking wok 20 to rotate, the plug-pull shaft 28 is gradually accelerated from the static state (initial state) with an angular velocity of 0 to a maximum angular velocity value; and at this moment, the food ingredients contained in the cooking wok 20 move on the inner surface of the wok body along with rotating of the cooking wok 20. The wok handle 28 rotating shaft is then decelerated gradually to the static state with the angular velocity of 0 after reaching the maximum angular velocity value; The cooking wok 20 reaches its maximum angle position when its angular velocity reaches 0, but due to inertia, the food ingredients in the wok body 1 continue to move towards the rotating direction of the cooking wok 20 and fly away from the inner surface of the wok body 1 by a certain height, and then fall back into the cooking wok 20 under influence of gravity to complete forward pot tossing action.

2) The servo motor 29 drives the plug-pull shaft 28 to rotate backwards to enable the cooking wok 20 to rotate counterclockwise so as to realize backward wok, tossing. The principle of backward wok tossing is identical with that of forward wok tossing, so that the principles will not be repeated here.

3) Back and forth, the plug-pull shaft 28 rotates forwards and backwards repeatedly and alternately, the cooking wok 20 rotates clockwise and counterclockwise repeatedly and alternately until the food ingredients are sufficiently stir-fried.

After the cooking wok completes dish cooking, as shown in FIG. 1, a dish bowl/plate gripper 2 serving as a dishing system is arranged on the mainframe structure 3, a dishing passage 10 is arranged on one side of the mainframe structure 3, a dish bowl/plate storage box 9 is arranged at a corresponding position of the dishing passage 10, a plurality of dish bowl/plates 8 are arranged in the dish bowl/plate storage box 9, and after the current dish bowl/plate 8 is used, the dish bowl/plate storage box 9 can drive the next dish bowl/plate 8 to move in place through ascending and descending or other driving modes for the dish bowl/plate gripper 2 to grip in the next time. The dish bowl/plate gripper 2 can rotate on the mainframe structure 3, FIG. 1 shows that the dish bowl/plate gripper 2 rotates counterclockwise (top view), the dish bowl/plate gripper 2 rotates counterclockwise to the position of the central cooking system 7 after gripping the dish bowl/plate 8 from the dish bowl/plate storage box 9, the central cooking system 7 drives the cooking wok 20 through the plug-pull shaft 28 to incline to pour the cooked food into the dish bowl/plate 8, the dish bowl/plate gripper 2 continues to rotate counterclockwise to the dish bowl/plate conveying belt 12, and the dish bowl/plate conveying belt 12 continuously runs to convey the dish bowl/plate 8 containing the dish to a target position.

As shown in FIG. 4, an auxiliary cooking area 34 is arranged at the lower half of the mainframe structure 3 and is used for special cooking requirements, especially for slow cooking that takes a long time to complete such as simmering, boiling and stewing. A plurality of auxiliary cooking wok handle sockets 35 are arranged in the auxiliary cooking area 34 and are connected with the wok handle plugs 26 of the cooking woks 20 to complete transferring of the cooking woks 20 from the central cooking system 7 to the auxiliary cooking area 34. The power supply in the wok handle sockets 35 connects to the wok handle plug 26 and drives the electromagnetic heating stove 19 arranged at the bottom of the cooking wok 20 to heat, and the long-time cooking is performed in the cooking wok 20.

As shown in FIG. 4, a wok washing water nozzle 36 is arranged below the auxiliary cooking area 34, after cooking is completed, the cooking wok 20 is transferred from the central cooking system 7 to the auxiliary cooking area 34, then the auxiliary cooking wok handle socket 35 rotates and turns the cooking wok 20 facing downwards towards the wok washing water nozzle 36, and the wok washing water nozzle 36 sprays wok washing liquid to the cooking wok 20 to perform wok washing. In order to collect used wok washing water waste, a wok washing water collection port is present within the washing area.

In order to guarantee freshness of the food ingredients in the food ingredient box 5, as shown in FIGS. 1 and 5, a refrigerating system 16 is arranged above the mainframe structure, a diverter 37 is mounted between each two adjacent long sides of the mainframe structure 3, and a cold air pipeline 15 is arranged on each diverter 37 and is communicated with the refrigerating system 16. As shown in FIG. 3, a cold air inlet 33 is formed in the side face of each food ingredient box 5, and the cold air pipeline 15 of each diverter 37 is communicated with the corresponding cold air inlet 33. Therefore, cold air released by the refrigerating system 16 can enter the food ingredient boxes 5 from the cold air inlets 33 through the cold air pipelines of the diverters 37 to realize preservation of the food ingredients stored in the food ingredient boxes 5.

Embodiment 2: differences of the embodiment from the embodiment 1 include that the mainframe structure 3 is not a closed structure, in other words, section of the mainframe structure 3 is not closed. In this case, moving stroke of the central cooking system 7 needs to be designed correspondingly, and the cooking wok 20 driven by the central cooking system 7 must be guaranteed to be capable of fetching ingredient from the food ingredient box 5 arranged on the mainframe structure 3.

When realizing the embodiment, an automatic control algorithm can be implemented using a controller, and the embodiment includes following steps:

1) The cooking device receives a cooking instruction for a certain dish, and the controller translates the instruction into various parameters such as cooking time and temperature according to a preset cooking scheme, type and amount of food ingredients and seasonings that need to be obtained by one cooking wok 20. The controller controls the central cooking system 7, which drives the cooking wok 20 to move, at the same time, the controller controls the electromagnetic heating stove 19 to heat the cooking wok 20 according to the preset cooking scheme, so as to enable the cooking wok 20 to fetch ingredient when the cooking wok is already at the required temperature. The said moving and heating at the same time enables and improves the cooking effect such as quick fry. In addition, moving and heating at the same time reduces wok pre-heating time waste and the heating power/temperature of the electromagnetic heating stove 19 is controlled according to the preset cooking scheme. The cooking wok 20 utilizes its own movement (rotating, ascending and descending, extending and contracting) to obtain the corresponding food ingredients and seasonings from the food ingredient boxes 5 according to the requirements of the preset cooking scheme until the requirements of the preset cooking scheme are met.

2) The controller controls the central cooking system 7 and drives the wok handle 2 to realize cooking wok 20 tossing, and the specific pot tossing principles and steps are as mentioned above, and therefore are not repeated here.

3) If the dish takes a long time to cook without the need to add more ingredient during cooking, the wok handle plug 26 is utilized to transfer the cooking wok 20 from the central cooking system 7 onto the auxiliary cooking wok handle socket 35 of the auxiliary cooking area 34. The energy supply unit is arranged in the auxiliary cooking wok handle socket 35 and supplies energy to the electromagnetic heating stove 19 of the cooking wok 20 so as to continuously heat the cooking wok 20, and both heating time and heating temperature are adopted according to the preset cooking scheme, so that requirements for long-time cooking of certain dishes are met.

4) After a dish cooking is finished, the controller controls the central cooking system 7 to drive the cooking wok 20 to rotate to the position of the dishing passage 10, and the dish bowl/plate gripper 2, the dish bowl/plate 8 and the dish bowl/plate conveying belt 12 are utilized for dishing to transfer the dish cooked by the cooking wok 20 onto the dish bowl/plate 8. If the dish takes a long time to cook, the cooking wok 20 can be transferred from the auxiliary cooking area 34 onto the central cooking system 7, and then the central cooking system 7 performs dishing; direct dishing from the auxiliary cooking area 34 can be realized by adding and arranging corresponding modularized mechanisms.

5) After dishing is finished, the wok handle plug 26 is utilized to transfer the cooking wok 20 into a washing area where the wok washing water nozzle 36 is positioned, the controller controls the wok washing water nozzle 6 to spray wok washing material to wash the cooking wok 20.

6) The cooking wok 20, after being washed, can receive an instruction for cooking the next dish.

When the above embodiment is implemented specifically, modularization can be performed on parts and specifically includes:

1) Modularization of the food ingredient boxes 5: structure and size of the food ingredient boxes 5 are uniform, the food ingredient boxes 5 are mutually replaceable, and when one food ingredient box 5 is damaged, it can be conveniently replaced by a new food ingredient box 5. When new food ingredients need to be put in or food ingredients need to be supplied, the empty food ingredient boxes 5 can be demounted from the ingredient box cabinets 6 and then loaded with new food ingredients or supplied with food ingredients, and the food ingredient boxes 5 already loaded with the new food ingredients or supplied with the food ingredients can be directly mounted at the corresponding empty positions of the ingredient box cabinets 6 to increase replacing and ingredient refilling speed. In addition, replacing food ingredient boxes 5 has minimum influence on the central cooking system 7.

2) Modularization of the ingredient box cabinets 6: structure and size of the ingredient box cabinets 6 are uniform and identical with and matched with those of mounting positions on the mainframe structure 3. Structure and size of the mourning positions for mounting the food ingredient boxes 5 on each food ingredient box cabinet 6 are uniform and identical with and matched with those of the food ingredient boxes. Same as the food ingredient boxes 5, two ways can be adopted for replacement.

3) modularization of auxiliary functional systems each auxiliary functional system is made in a form of module body, in other words, each auxiliary functional system is identical with and matched with structure and size of the mounting positions on the mainframe structure 3, the user can re-arrange the positions of the auxiliary functional systems according to actual needs, such as, the dish bowl/plate gripper 2 is arranged at a position close to a restaurant serving window or at a position convenient for customer pick up. When a new auxiliary functional system needs to be integrated on the mainframe structure 3, the user only needs to demount the food ingredient box cabinet 6 corresponding to a position at which the auxiliary functional system is about to be arranged from the mainframe structure 3; when a mounting position of the mainframe structure 3 is idle, the user can directly mount the modularized body of the new auxiliary functional system onto the idle position of the mainframe structure 3.

The number of the cooking woks 20 can be designed according to needs of cooking various dishes at the same time and on a large scale.

Size of the food ingredient boxes 5 can be designed according to actual needs. The number of the food ingredient boxes 5 stacked in each food ingredient box cabinet 6 can be increased and decreased according to type of food ingredients needing to be cooked, but height of the ingredient box cabinets 6 must be ensured to be identical with and matched with that of the mainframe structure 3.

The number of the food ingredient fetching outlets 14 of the food ingredient boxes 5 can be set according to the type of the food ingredients. When one food ingredient is stored in each food ingredient box 5, only one food ingredient fetching outlet 14 needs to be arranged. When a plurality of different food ingredients are stored in one food ingredient box 5, the inner cavity of a box body of the food ingredient box 5 can be divided into a plurality of storage spaces by partitions, one food ingredient is stored in each storage space, the food ingredient box 5 is provided with one food ingredient fetching outlet 14 corresponding to each storage space, in other words, each food ingredient in one food ingredient box 5 has one or more independent food ingredient fetching outlets 14. For the circumstance that different food ingredients are stored in one food ingredient box 5, a same food ingredient fetching outlet 14 can be shared.

Although the above embodiment has described the concept and the embodiment of the invention in a detailed manner by referring to the drawings. Common technical personnel in the field can realize that the invention still can be improved and altered variedly without breaking away from the range limited by the Claims, such as the layout and specific structural composition of the functional units, so that it is not repeated here one by one.

1. A fully-automatic intelligent multi-wok cooking method, which is characterized, in that it includes at least the following steps:
a driving mechanism drives the cooking woks to the food ingredient storage and supply system for ingredient fetching;
after ingredient fetching action is completed, the cooking woks are heated while being rotated for wok tossing;
wok moving, ingredient fetching, wok heating and tossing repeats until cooking completes, the cooking wok(s) is(are) then driven to the product delivery system for dishing.

2. According to claim 1, the fully-automatic intelligent multi-wok cooking method is characterized in that the food ingredient storage and supply system is arranged on a mainframe structure and comprises a plurality of food ingredient boxes with food ingredient fetching outlets. The cooking woks move to the corresponding positions of the food ingredient fetching outlets that matched with the food ingredient boxes for ingredient fetching.

3. According to claim 1, the fully-automatic intelligent multi-wok cooking method is characterized in that the movement of the cooking woks includes one of or a combination of two or more of rotating, ascending and descending, extending and contracting.

4. According to claim 3, the fully-automatic intelligent multi-wok cooking method is characterized in that the rotating of a plurality of the cooking woks includes single-pot rotating and integral rotating. Said single-pot rotating angle range of the cooking woks is the result of 360 degrees divided by the number of the cooking woks.

5. According to claim 1, the fully-automatic intelligent multi-wok cooking method is characterized in that said heating refers to pre-heating the cooking woks in the process when the cooking woks are moving. The heating temperature meets the requirements of cooking needs.

6. According to claim 1, the fully-automatic intelligent multi-wok cooking method is characterized in that wok tossing is realized by connecting one side of each cooking wok with a rotating shaft, that drives the individual cooking woks to rotate independent of each other.

7. According to claim 6, the fully-automatic intelligent multi-wok cooking method is characterized in that each rotating shaft rotates to drive the corresponding cooking wok to rotate; each rotating shaft is gradually accelerated from the static state with an angular velocity of 0 to a maximum angular velocity value; each rotating shaft is decelerated gradually to the static state with the angular velocity of 0 after reaching the maximum angular velocity value; and when being in the static state, the corresponding cooking wok is at its maximum angle position.

8. According to claim 1, the fully-automatic intelligent multi-wok cooking method is characterized in that when performing time consuming slow cooking, the cooking wok(s), that is(are) performing the slow cooking, is(are) driven to move and is(are) transferred from the said driving mechanism onto an auxiliary cooking unit, and the auxiliary cooking unit continuously heats the cooking woks until the needs of slow cooking are met.

9. According to claim 1, the fully-automatic intelligent multi-wok cooking method is characterized in that after cooking and/or dishing is completed, the corresponding cooking wok(s) is(are) driven to move and is(are) transferred from the driving mechanism onto a washing unit, and the washing unit washes the cooking woks.
